(19) United States
(12) Patent Application Publication
(10) Pub. No.: US 2015/0313374 A1
(43) Pub. Date: Nov. 5, 2015

(54) Changing Table Cover

(71) Applicant: Christine H. Johnson, (US)

(72) Inventor: Christine H. Johnson, (US)

(21) Appl. No.: 14/269,089

(22) Filed: May 3, 2014

(51) Int. Cl. A47C 31/11; A47D 5/00; B60N 2/28; A47D 15/00

(52) U.S. Cl. CPC A47C 31/11; A47D 15/006; A47D 5/00; B60N 2/2881

(57) ABSTRACT

A reusable cover which consists of a stretchable washable material with a sewn in elastic band to expand the material over different shaped and sized public washroom baby changing tables. The cover protects the baby from the unsanitary and hard surfaces of baby changing stations. The cover has two holes to accommodate the safety strap that holds the child in place. The holes are on both sides of the material so either side can be used equally. Since the material has the sewn in elastic band it can easily be removed by one hand if necessary and then rolled up into a small compact bundle and placed into a diaper bag for reuse.

### CROSS-REFERENCE TO RELATED APPLICATIONS

Patent 20070078419 issued Apr. 7, 2007 Bredfeldt, Barbara

Patent 20120317722 issued Dec. 20, 2012 Pary, Jennifer

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISK APPENDIX

Not applicable

### DESCRIPTION OF THE PRIOR ART

Patent 20120317722 issued Dec. 20, 2012 Pary, Jennifer—Changing table cover—This patent discloses a piece of material that converts from a carrying tote to a changing table cover. Shortcomings of this patent consist of being overly complicated and large. There are several specific folds one has to make to turn it into a carrying bag and has clips to attach to table which add to time spent in restroom. This item does not take into consideration the buckle that secures the child to the table. Limited use to changing table. This item is also not unisex. A man would not be comfortable carrying or using this invention.

Patent 20070078419 issued Apr. 7, 2007 Bredfeldt, Barbara—Changing table cover—This patent describes a table cover with adhesive strips and perforations. Shortcomings of this patent consist of being time consuming since adhesive strips are used as well as being on a roll that one has to tear off. This item does not take into consideration the buckle that secures child. Limited use to changing table.

### SUMMARY OF THE INVENTION

The present invention is a piece of material that wraps around the changing table to provide a sanitary and comfortable layer of protection between the surface of the changing table and child. The invention fits any size changing table and accommodates the safety belt that secures the child onto the table. The invention can be folded quickly into a small roll for easy transport.

### BRIEF DESCRIPTION OF THE DRAWING

FIG. 1 is a perspective view of the interior of the changing table cover.

FIG. 2 is a perspective view of the exterior of the changing table cover

FIG. 3 is a perspective view of the exterior of the changing table cover on a changing table

FIG. 4 is a perspective view of the exterior of the changing table cover on a changing table medium viewpoint

FIG. 5 is a perspective view of the exterior of the changing table cover on a changing table close-up viewpoint

### DETAILED DESCRIPTION OF THE INVENTION

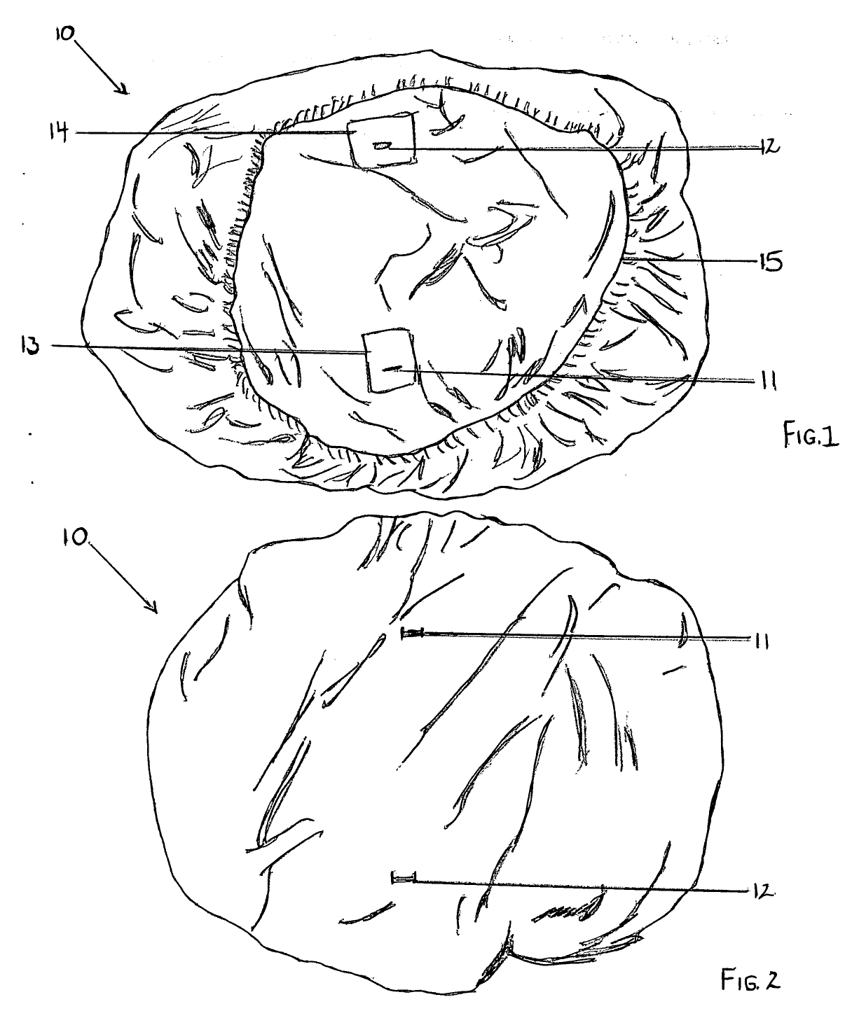

Referring now to the invention in more detail, in FIG. 1 shows cover 10 lying flat with an elastic opening 15 and two holes 11 and 12 with re-enforced backing 13 and 14 around holes 11 and 12. 13 and 14 are sewn around 11 and 12 to strengthen holes 11 and 12. Reinforced stitching surrounds 11 and 12 to strengthen holes and prevent tearing.

Lying flat 10 is approximately 30 inches across and when stretched approximately 50 inches across. Holes 11 and 12 are approximately 1 inch across and ¼ inch wide.

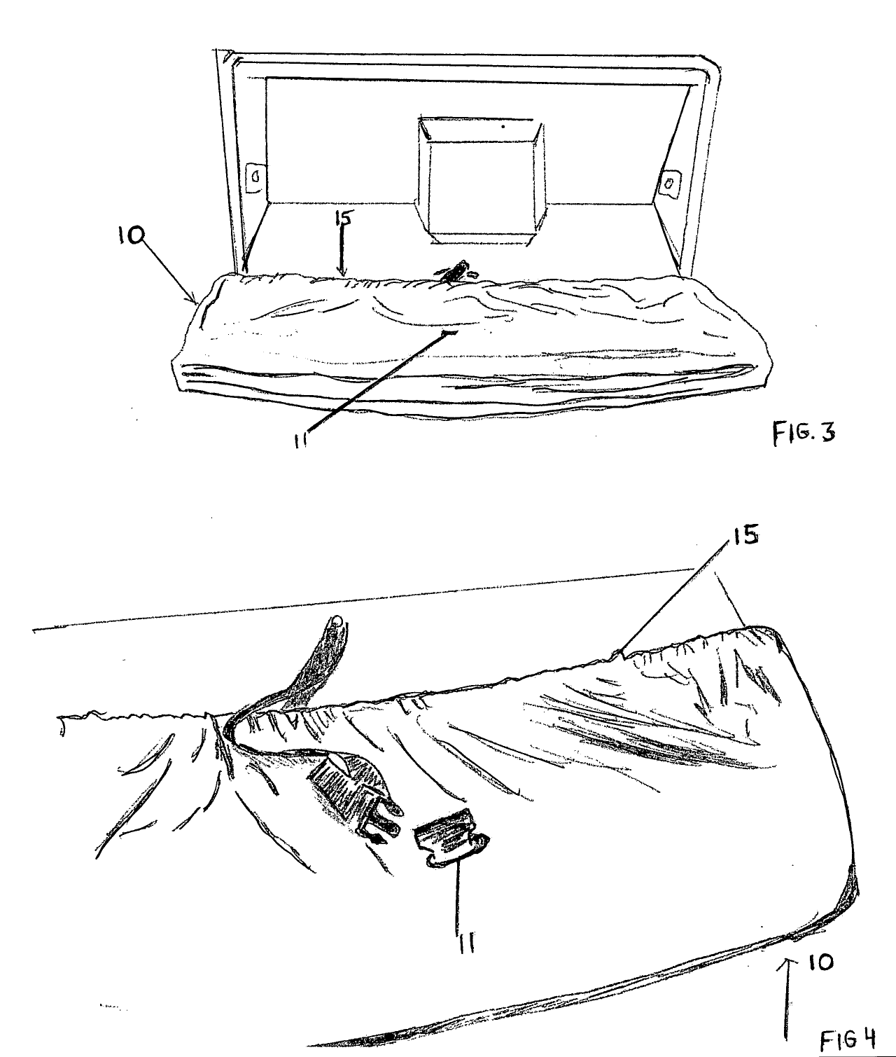

FIG. 2 shows the exterior view of 10 and holes 11 and 12. The holes are approximately 10 inches from the center of 10.

The construction of 10 can be of a stretchable flexible washable fabric approximately 1 yard with an elastic material 15 sewn into the edge of 10 which will conform to the shape of any size table.

Disposable material could also be used as long as the material had an elastic material such as 15 as shown in FIG. 1 and holes such as 11 and 12 were applied as in FIG. 1 and FIG. 2.

FIG. 3 shows 10 completely covering a changing table with one hole 11 showing. 10 is constructed so as either side of 10 can be used on table with either hole 11 or 12 available to accommodate the safety buckle on changing tables.

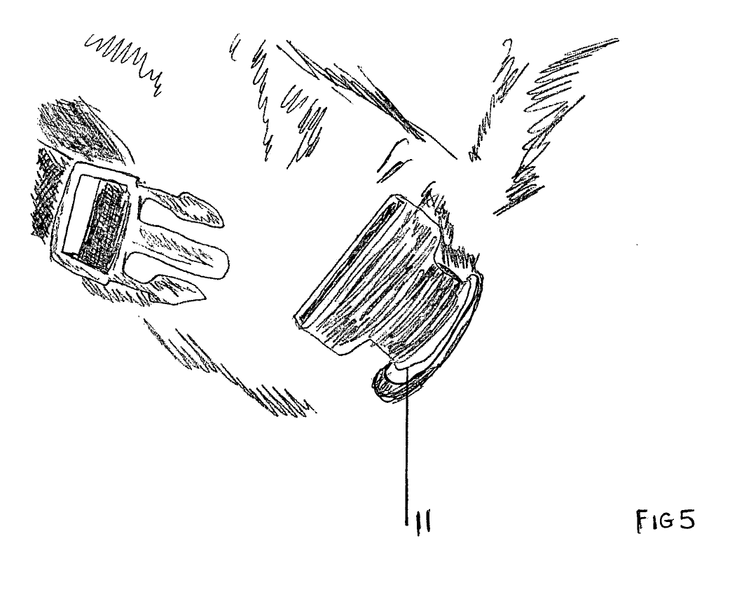

FIG. 4 and FIG. 5 shows 10 on a changing table with a buckle through 11.

1. The advantages of the present invention include without limitations that it can be folded or it can be rolled into a compact form. Due to the elastic sewn into the material it can conform and attach itself to various types of changing tables found in public restrooms from those ranging in size from 34½×17 to 35½×19.
Due to having two holes on each side of the material the buckle on the changing table can be put through either side of the material and which means both side can be used equally.
This cover is not limited to changing table and can be used as a protective barrier for use in cars that have fold down seats with the material covering the car seat which then can be used as a make shift changing table protecting the car seat and the child.
The cover can also be used in restaurants that make available high chairs for children. After many uses by others the chairs accumulate food debris and are unsanitary. The cover can be used as a protective barrier for the restaurant high chair and booster seat. The same principle applies to grocery cart seats that have been used by numerous members of the public as well as food items set on-top of the seating area.
